(19) United States
(12) Patent Application Publication
(10) Pub. No.: US 2026/0110292 A1
(43) Pub. Date: Apr. 23, 2026

(54) PIVOT BASED SHAPE MEMORY ALLOY ACTUATOR

(71) Applicant: SCHUKRA BERNDORF GMBH, Berndorf (AT)

(72) Inventor: Swapnil Madhukar Pable, Aschaffenburg (DE)

(21) Appl. No.: 19/366,056

(22) Filed: Oct. 22, 2025

Related U.S. Application Data
(60) Provisional application No. 63/710,477, filed on Oct. 22, 2024.

(51) Int. Cl. F03G 7/06

(52) U.S. Cl. CPC F03G 7/06143; F03G 7/06114

(57) ABSTRACT

A shape memory alloy (SMA) actuator includes a lever pivotable about a pivot axis between a first position and a second position, a mount coupled to the lever and radially offset from the pivot axis, and an actuator coupled to the lever and moveable between an extended position corresponding to the first position of the lever and a retracted position corresponding to the second position of the lever. The SMA actuator also includes a shape memory alloy (SMA) element connected to the mount. In response to heat being applied to the SMA element, the SMA element changes between an extended state and a contracted state. The lever is configured to pivot from the first position corresponding to the SMA element being in the contracted state to the second position corresponding to the SMA element being in the extended state.

### CROSS-REFERENCE TO RELATED APPLICATIONS

This application claims priority to U.S. Provisional Patent Application No. 63/710,477, filed on October 22, 2024, the entire contents of which is incorporated herein by reference.

### FIELD OF THE DISCLOSURE

The present disclosure relates to electronically operated actuators, and more specifically to shape memory alloy actuators.

### BACKGROUND OF THE DISCLOSURE

Various products in the automotive, aviation, marine, industrial, and domestic applications employ electronically operated actuators. One such type of electronically operated actuator is a shape memory alloy (SMA) actuator. A typical shape memory alloy actuator includes a metal element that changes form in response to heat being applied to the metal element. The metal element is often coupled to a mechanism, which is actuated when the metal element changes form.

### SUMMARY OF THE DISCLOSURE

Conventional SMA actuators face several technical challenges that limit their broader adoption and operational efficiency. Notably, existing designs often suffer from limited actuation range, suboptimal force transmission, and increased frictional losses, which can reduce the longevity and reliability of the SMA element. Furthermore, many SMA actuators lack precise positional control, making them unsuitable for applications requiring accurate and repeatable movement.

The present disclosure addresses these technical problems by providing an improved SMA actuator. The actuator may include a lever pivotable about a pivot axis, with mounts radially offset from the axis to optimize force transmission. The SMA element is connected to the mount and configured to change between extended and contracted states in response to thermal activation. The lever pivots between defined positions corresponding to the state of the SMA element, which may enable both two-position and continuous adjustment actuation. The inclusion of rotatable mounts (e.g., bearings) minimizes frictional forces, thereby enhancing the durability and operational efficiency of the SMA element. Additionally, the actuator may incorporate a spring bias and an emergency release mechanism, ensuring reliable operation even in the event of power failure or SMA element malfunction.

By integrating position sensors and a controller, the actuator may achieve precise positional control. The actuator may also have a modular design that enables stacking of multiple actuators to achieve greater force output and expanded functionality. These technical solutions overcome limitations of conventional SMA actuators and may be suitable for a wide range of applications.

In some aspects, the techniques described herein relate to a shape memory alloy (SMA) actuator including: a lever pivotable about a pivot axis between a first position and a second position; a mount coupled to the lever and radially offset from the pivot axis; and a shape memory alloy (SMA) element connected to the mount, wherein the SMA element, in response to heat being applied to the SMA element, changes between an extended state and a contracted state; wherein the lever pivots from the first position corresponding to the SMA element being in the contracted state to the second position corresponding to the SMA element being in the extended state.

In some aspects, the techniques described herein relate to a SMA actuator, wherein the mount is a first mount defining a first radial offset from the pivot axis in a first direction, and wherein the SMA actuator further includes a second mount coupled to the lever and defining a second radial offset from the pivot axis in a second direction opposite the first direction.

In some aspects, the techniques described herein relate to a SMA actuator, wherein the first radial offset is the same as the second radial offset.

In some aspects, the techniques described herein relate to a SMA actuator, wherein the SMA element is a first SMA element is connected to the first mount and configured to exert a biasing force on the first mount in a direction perpendicular to and offset from the pivot axis, wherein the SMA actuator further includes a second SMA element connected to the second mount and configured to exert a biasing force on the second mount in a direction perpendicular to and offset from the pivot axis.

In some aspects, the techniques described herein relate to a SMA actuator, wherein when heat is applied to the first SMA element initially in the extended state, the first SMA element changes to the contracted state and exerts a force on the second SMA element via the lever, thereby changing the second SMA element from the contracted state to the extended state and pivoting the lever from the second position to the first position.

In some aspects, the techniques described herein relate to a SMA actuator, wherein when heat is applied to the second SMA element initially in the extended state, the second SMA element changes to the contracted state and exerts a force on the first SMA element via the lever, thereby changing the first SMA element from the contracted state to the extended state and pivoting the lever from the first position to the second position.

In some aspects, the techniques described herein relate to a SMA actuator, wherein the lever is pivotable to the first position in response to heat being applied to the first SMA element and to the second position in response to heat being applied to the second SMA element, and wherein the lever is pivotable to a desired position among an infinite number of possible positions between the first position and the second position by heating either the first SMA element or the second SMA element and stopping the lever in response to a sensor being triggered.

In some aspects, the techniques described herein relate to a SMA actuator, further including a controller that is in electrical communication with a power source, a first sensor, and a second sensor, wherein the first sensor is activated when the lever is in the first position and sends a signal to the controller indicating to cutoff power supply to the first SMA element from the power source, and wherein the second sensor is activated when the lever is in the second position and sends a signal to the controller indicating to cutoff power supply to the second SMA element from the power source.

In some aspects, the techniques described herein relate to a SMA actuator, wherein the mount is rotatably mounted to the lever, thereby minimizing frictional forces between the SMA element and the mount as the SMA element bears against the mount when changing between the extended state and the contracted state.

In some aspects, the techniques described herein relate to a SMA actuator, further including an actuator coupled to the lever and moveable between an extended position corresponding to the first position of the lever and a retracted position corresponding to the second position of the lever.

In some aspects, the techniques described herein relate to a SMA actuator, wherein the actuator is pivotably coupled to an elongated slot adjacent a distal end of the lever, the elongated slot defining a slot axis along which the actuator may translate when the actuator moves between the extended position and the retracted position.

In some aspects, the techniques described herein relate to a SMA actuator, wherein the actuator is movable along an actuator axis that is perpendicular to the pivot axis when moving between the extended position and the retracted position.

In some aspects, the techniques described herein relate to a SMA actuator, wherein the mount is rotatably mounted to the lever, thereby minimizing frictional forces between the SMA element and the mount as the SMA element bears against the mount when changing between the extended state and the contracted state.

In some aspects, the techniques described herein relate to a shape memory alloy (SMA) actuator including: a lever pivotable about a pivot axis between a first position and a second position; an actuator coupled to the lever and moveable between an extended position corresponding to the first position of the lever and a retracted position corresponding to the second position of the lever; and a shape memory alloy (SMA) element coupled to the lever, wherein the SMA element, in response to heat being applied to the SMA element, changes between an extended state and a contracted state; wherein the lever pivots from the first position corresponding to the SMA element being in the contracted state to the second position corresponding to the SMA element being in the extended state.

In some aspects, the techniques described herein relate to a SMA actuator, wherein the actuator is movable along an actuator axis that is perpendicular to the pivot axis when moving between the extended position and the retracted position.

In some aspects, the techniques described herein relate to a SMA actuator, wherein the actuator is pivotably coupled to an elongated slot adjacent a distal end of the lever, the elongated slot defining a slot axis along which the actuator may translate when the actuator moves between the extended position and the retracted position.

In some aspects, the techniques described herein relate to a SMA actuator, further including a controller; a power source; a first sensor; and a second sensor, wherein the first sensor is configured to detect when the lever is in the first position, wherein the second sensor is configured to detect when the lever is in the second position, and wherein the controller is configured to control the power source based on feedback from the first sensor and the second sensor.

In some aspects, the techniques described herein relate to a SMA actuator, further including a spring biasing the lever toward the second position.

In some aspects, the techniques described herein relate to a SMA actuator, further including a housing enclosing the lever and the SMA element.

In some aspects, the techniques described herein relate to a SMA actuator, further including a cable coupled to the lever and extending outside of the housing.

Other features and aspects of the disclosure will become apparent by consideration of the following detailed description and accompanying drawings.

### BRIEF DESCRIPTION OF THE DRAWINGS

FIG. 1 is a schematic view of a shape memory alloy (SMA) actuator in accordance with an embodiment of the disclosure, illustrating two SMA elements connected to a lever when the lever is in a first position.

FIG. 2 is a schematic view of the SMA actuator of FIG. 1 illustrating the lever in a second position.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Various terms and/or phrases describing a positional or directional reference, such as “top”, “bottom”, “front”, “rear”, “left”, “right”, “above”, “below”, “vertical”, “horizontal”, etc. are for purposes of describing the disclosure to one skilled in the art as it pertains to the frame of reference of the drawings, but should not be interpreted as limiting.

### DETAILED DESCRIPTION

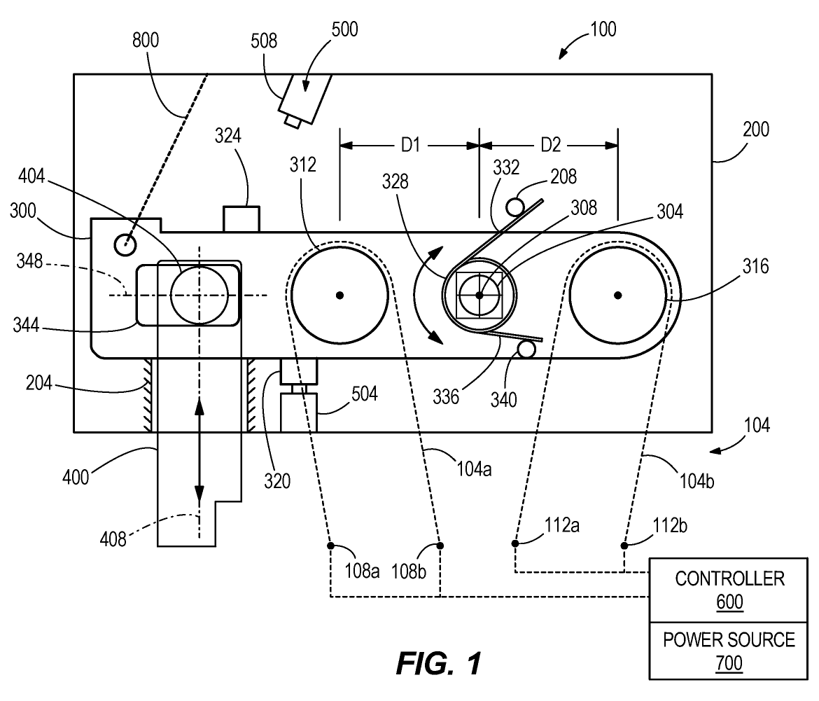

FIG. 1 illustrates a shape memory alloy (SMA) actuator 100 that may be employed to actuate various latches, levers, valves, gear trains, linkages, or other various mechanisms. Once actuated, the SMA actuator 100 may, for example, unlock/lock a door or adjust the translational/rotational position of an object. The SMA actuator 100 includes an SMA element 104 that can change length depending on its temperature. In the illustrated embodiment, the SMA element 104 is a wire, while in other embodiments, the SMA element 104 may alternatively be an SMA tape, foils, sheets, or other suitable forms.

In general, the SMA element 104 may exist in two different solid-state phases—a martensite phase at a first, lower temperature and an austenite phase at a second, higher temperature. The SMA element 104 is configured to change its shape in response to thermal activation from a deformed or “extended state” during the martensite phase to a pre-deformed or “contracted state” during the austenite phase. Typically, the phase transformation is reversible and independent of time. An electric current is applied to flow through the SMA element 104 to thermally activate the SMA element 104. Due to electrical current flowing through the SMA element 104 and the wire’s resistance to the current, the SMA element 104 is heated. The change in temperature causes the length change (i.e., from the extended state to the contracted state). In other embodiments, external heating elements arranged adjacent to the SMA element 104 may alternatively be employed to heat the SMA element 104, e.g., separate current-carrying wires, proximate heating element, radiator, heat exchange fluid system, etc.

In the illustrated embodiment, the SMA element 104 is composed of a Nickel-Titanium (NiTi) alloy—e.g., binary NiTi alloys. In some embodiments, ternary or quaternary elements (e.g., carbon, oxide, copper, chromium, etc.) may be added to the NiTi alloy SMA element 104. In other embodiments, the SMA element 104 may be composed of copper-based alloys, such as CuZnAl, CuAlNi, or the like.

With reference to FIG. 1, the SMA actuator 100 further includes a housing 200, a lever 300 pivotably coupled to the housing 200, and an actuator 400 pivotably coupled to the lever 300. A controller 600 and a power source 700 (FIG. 4) may also be provided to initiate and manage the electrical current supplied to the SMA actuator 100.

The housing 200 at least partially encases the lever 300 and the actuator 400. A portion of the actuator 400, however, extends beyond the housing 200 to interact with various latches, levers, valves, gear trains, linkages, or other various mechanisms. Specifically, the housing 200 includes an aperture 204 through which the actuator 400 extends and translates. In other embodiments, various latches, levers, valves, gear trains, linkages, or other various mechanisms may be directly coupled to the lever 300 without the actuator 400. As explained in further detail below, opposite distal ends (i.e., 108a, 108b, 112a, 112b) of the SMA element 104 are anchored to the housing 200, such that an amount of the SMA element 104 does not change.

In other embodiments, the housing 200 may have a different form factor than illustrated in FIG. 1 without deviating from the scope of the disclosure. For example, the housing may have a different geometry altogether and/or have more apertures through the housing 200. In such an embodiment, the SMA element 104 would have greater exposure to its immediate surroundings (e.g., ambient air, fluid, etc.) rather than being fully encased in the housing 200. This may be advantageous for purposes of efficient heat dissipation and rapid cooling of the SMA elements 104 after being heated (e.g., via electrical current being fed through).

With continued reference to FIG. 1, the lever 300 is pivotably coupled to the housing 200 about a shaft 304 defining a pivot axis 308. The lever 300 includes a pair of mounts 312, 316, where one mount 312 is disposed adjacent one side of the shaft 304 and the other mount 316 is disposed adjacent another side of the shaft 304. In other words, the mounts 312, 316 are disposed on radially opposite sides of the shaft 304. That is, both mounts 312, 316 are radially offset from the pivot axis 308 on opposite sides, as indicated by radial offset D1, D2. As illustrated, the radial offset D1, D2 of both mounts 312, 316 relative to the pivot axis 308 is the same, while in other embodiments, the radial offset D1, D2 of the mounts 312 relative to the pivot axis 308 may alternatively be different to provide a mechanical advantage on one side. The mounts 312, 316 of the illustrated embodiment are bearings, as referred to hereinafter.

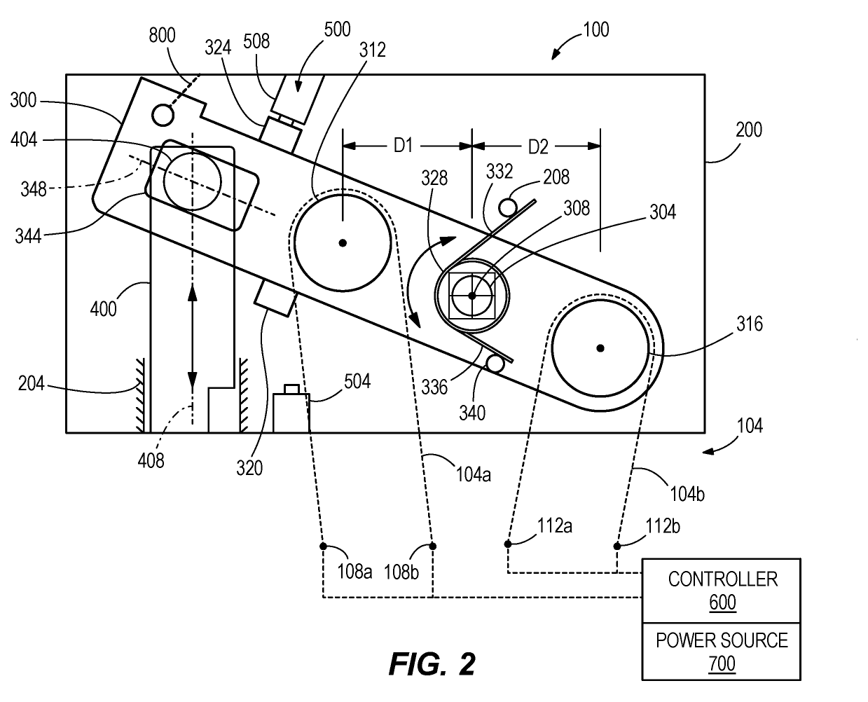

The lever 300 is pivotable about the shaft 304 between a first position (as illustrated in FIG. 1) and a second position (FIG. 2). A position sensor assembly 500 is disposed within the housing 200 and configured to detect when the lever 300 reaches the first position, the second position, or a desired position among an infinite number of possible positions between the first and second positions. In the first position, a first stop 320 of the lever 300 interfaces with a first position sensor 504, while in the second position, a second stop 324 of the lever 300 interfaces with a second position sensor 508. In other embodiments, various sensors may be configured to interact with the lever 300, such as limit switches, optical sensors, and other similar sensors.

The lever 300 is biased toward the second position via a spring 328. The spring 328 is a torsion spring that is disposed around the shaft 304 of the lever 300. The spring 328 includes a first leg 332 that is engaged with a first post 208 of the housing 200 and a second leg 336 that is engaged with a second post 340 of the lever. As such, the second leg 336 of the spring 328 exerts a force on the second post 340 of the lever 300 tending to bias the lever 300 toward the second position.

The SMA actuator 100 further includes an emergency release cable 800 that is coupled to the lever 300. The emergency release cable 800 is accessible from outside the housing 200 and capable of being manually pulled to actuate the lever 300 to the second position. This may be advantageous to allow the SMA actuator 100 to still operate even if power supply from the power source 700 is cutoff. The spring 328 also maintains the lever 300 in the second (open) position, for example, when the SMA actuator 100 has lost power and the emergency release cable 800 has been actuated. As such, the spring 328 maintains the lever 300 in the second position if the SMA element 104 is broken, misaligned, or otherwise not working properly.

The SMA element 104 is also coupled to and capable of actuating the lever 300 between the first position and the second position. Specifically, a first SMA element 104a is wrapped around the bearing 312 and a second SMA element 104b is wrapped around the bearing 316. The first SMA element 104a includes a first end 108a and a second end 108b that are both coupled to the housing 200 (or some other rigid body) to inhibit movement of the first end 108a and the second end 108b. Between the first end 108a and the second end 108b, the first SMA element 104a is wrapped around at least a portion of the outer periphery of the bearing 312. The amount of material of the first SMA element 104a between the first end 108a and the second end 108b does not change, but the length of the first SMA element 104a may change as mentioned above. Specifically, when heat (e.g., via electrical current) is applied to the first SMA element 104a, the first SMA element 104a decreases in length (i.e., changes to the contracted state) and exerts a biasing force on the bearing 312 to pivot the lever 300 to the first position. Specifically, the first SMA element 104a exerts a downward force on the bearing 312 (based on the frame of reference of FIG. 1) in a direction perpendicular and offset from the pivot axis 308, thereby pivoting the lever 300 to the first position. When the first SMA element 104a cools (i.e., returns to ambient temperature when no heat is applied), the first SMA element 104a is allowed to deform and increase in length (i.e., change to the extended state) when a sufficient force is applied to the first SMA element 104a.

The second SMA element 104b includes a first end 112a and a second end 112b that are both coupled to the housing 200 (or some other rigid body) to inhibit movement of the first end 112a and the second end 112b. Between the first end 112a and the second end 112b, the second SMA element 104b is wrapped around at least a portion of the outer periphery of the bearing 316. The amount of material of the second SMA element 104b between the first end 112a and the second end 112b does not change, but the length of the second SMA element 104b may change as mentioned above. Specifically, when heat (e.g., via an electrical current) is applied to the second SMA element 104b, the second SMA element 104b decreases in length (i.e., changes to the contracted state) and exerts a biasing force on the bearing 316 to pivot the lever 300 to the second position. Specifically, the second SMA element 104b exerts a downward force on the bearing 316 (based on the frame of reference of FIG. 1) in a direction perpendicular and offset from the pivot axis 308, thereby pivoting the lever 300 to the second position. When the second SMA element 104b cools (i.e., returns to ambient temperature when no heat is applied), the second SMA element 104b is allowed to deform and increase in length (i.e., change to the extended state) when a sufficient force is applied to the second SMA element 104b.

The bearings 312, 316 are able to rotate, which decreases frictions between the bearings 312, 316 and the first and second SMA elements 104a, 104b as they change from the contracted state and the extended state, and vice versa. In such an embodiment, friction between the bearings 312, 316 and the SMA element 104 is decreased and the longevity of the SMA element 104 is increased. In other embodiments, the bearings 312, 316 may not rotate, such that the SMA element 104 slides along the bearings 312, 316 as the length of the SMA element 104 changes. In such embodiments, the bearings 312 may be made of a low friction material.

With reference to FIG. 1, the actuator 400 is disposed adjacent a distal end of the lever 300 away from the pivot axis 308 to maximize the distance through which the actuator 400 travels as the lever 300 pivots. The actuator 400 is pivotably coupled to the lever 300 via a pivot joint 404 which, in turn, is received in an elongated slot 344 of the lever 300. The elongated slot 344 allows the pivot joint 404, and therefore the actuator 400, to translate relative to the lever 300. Specifically, the elongated slot 344 defines a slot axis 348 along which the pivot joint 404, and therefore the actuator 400, slides (i.e., translates). When the lever 300 is in the first position, the pivot joint 404 of the actuator 400 is adjacent a first side (i.e., right side with reference to FIG 1) of the elongated slot 344. When the lever 300 is in the second position, the pivot joint 404 of the actuator is adjacent a second, opposite side (i.e., left side with reference to FIG. 1) of the elongated slot 344. Therefore, the pivot joint 404, and therefore the actuator 400, slide along the slot axis 348 as the pivot joint 404 moves from the first side of the slot 344 to the second side of the slot 344. In other embodiments, the lever 300 may alternatively be directly coupled to and transfer a rotational motion to various latches, levers, valves, gear trains, linkages, or other various mechanisms via a rigid pin connection.

The actuator 400 is also movable between an extended position corresponding to the lever 300 being in the first position and a retracted position corresponding to the lever 300 being in the second position. In the retracted position, the actuator 400 may or may not extend beyond the periphery of the housing 200. In the extended position, the actuator 400 extends beyond the periphery of the housing 200 a greater distance than when in the retracted position. The actuator 400 moves along an actuation axis 408 when translating through the aperture 204 between the extended position and retracted position. The actuator 400 may ultimately be coupled to and configured to actuate various latches, levers, valves, gear trains, linkages, or other various mechanisms.

During operation, the SMA actuator 100 can be used as a two-position actuator and/or a continuous adjustment actuator. As a two-position actuator, heat (e.g., via electrical current) is applied to either the first SMA element 104a or the second SMA element 104b at a time. So, for example, when the lever 300 is in the first position, the first SMA element 104a is in the contracted state and the second SMA element 104b is in the extended state, meaning that the first SMA element 104a exerts a biasing force on the lever 300 (via bearing 312) that overcomes the biasing force of the second SMA element 104b on the lever 300 (via bearing 316). At this point, the first stop 320 of the lever 300 triggers the first position sensor 504, which relays a signal to the controller 600 indicating that the lever 300 is in the first position. At this point, the actuator 400 is in the extended position. The lever 300 remains in the first position until heat is applied to the second SMA element 104b. When heat (e.g., via electrical current) is applied to the second SMA element 104b (and no heat or electrical current to the first SMA element 104a), the second SMA element 104b transitions to the austenite phase, such that the second SMA element 104b moves from the extended state to the contracted state. Here, the second SMA element 104b exerts a biasing force on the lever 300 (via bearing 316) that overcomes the biasing force of the first SMA element 104a on the lever 300 (via bearing 312). That said, the lever 300 pivots about the shaft 304 from the first position toward the second position, thereby exerting a force on the first SMA element 104a via the bearing 312 sufficient to deform the first SMA element 104a to the extended state. Meanwhile, the actuator 400 moves from the extended position to the retracted position. The second stop 324 of the lever 300 triggers the second position sensor 508, which relays a signal to the controller 600 indicating that the lever 300 is in the second position. The lever 300 remains in the second position until heat is applied heat is applied to the first SMA element 104a. The lever 300 returns to the first position when heat (e.g., electrical current) is applied to the first SMA element 104a under the same principles just described. Depending on the application, various latches, levers, valves, gear trains, linkages, and/or other various mechanisms may be coupled to the actuator 400 to initiate movement thereof.

As a continuous adjustment actuator, the SMA actuator 100 in a similar manner as previously explained, but now, heat (e.g., electrical current) is applied to one of the SMA elements 104a, 104b for a period of time until the lever 300—or actuator 400—reaches a desired position among an infinite number of possible positions between and including the first position and the second position.

The position sensor assembly 500 may be employed to detect when the lever 300—or actuator 400—reaches the desired position between the first position and the second position and relay a signal to the controller 600 indicating to cutoff supply of the heat (e.g., electrical current). Although the illustrated embodiment employs two position sensors 504, 508, in other embodiments, fewer or greater position sensors may be alternatively employed. Still, in other embodiments, various sensors or timers may be used, such as electrical resistance sensors, limit switches, optical sensors, and other similar sensors. In such an embodiment, the lever 300 moves toward the first position as the heat (e.g., electrical current) is applied to the first SMA element 104a and the actuator 400 is stopped when the sensor or timer is triggered. Similarly, the lever 300 moves toward the second position as heat (e.g., electrical current) is applied to the second SMA element 104b and the actuator 400 is stopped when the sensor or timer is triggered.

Based on the travel distance requirements of the actuator 400 and available package space, design parameters such as wire length, size of lever/actuator, radial offset D1, D2 of bearings 312, 316 relative to the pivot axis 308, wire diameter, voltage, current flow, and other parameters may be adjusted.

Furthermore, multiple SMA actuators 100 may be stacked (and coupled together) or combined to achieve desired outcome and performance characteristics. Specifically, multiple SMA actuators 100 stacked on top of each other can work together in unison to generate a force that is greater than the force generated by a single SMA actuator 100. In an embodiment with multiple SMA actuators stacked and coupled together is capable of actuating various latches, valves, gear trains, linkages, or other various mechanisms to, for example, unlock/lock a door or adjust the translational/rotational position of an object.

Various features of the disclosure are set forth in the following claims.

What is claimed is:

1. A shape memory alloy (SMA) actuator comprising:
a lever pivotable about a pivot axis between a first position and a second position;
a mount coupled to the lever and radially offset from the pivot axis; and
a shape memory alloy (SMA) element connected to the mount, wherein the SMA element, in response to heat being applied to the SMA element, changes between an extended state and a contracted state;
wherein the lever pivots from the first position corresponding to the SMA element being in the contracted state to the second position corresponding to the SMA element being in the extended state.

2. The SMA actuator of claim 1, wherein the mount is a first mount defining a first radial offset from the pivot axis in a first direction, and wherein the SMA actuator further includes a second mount coupled to the lever and defining a second radial offset from the pivot axis in a second direction opposite the first direction.

3. The SMA actuator of claim 2, wherein the first radial offset is the same as the second radial offset.

4. The SMA actuator of claim 2, wherein the SMA element is a first SMA element is connected to the first mount and configured to exert a biasing force on the first mount in a direction perpendicular to and offset from the pivot axis, wherein the SMA actuator further includes a second SMA element connected to the second mount and configured to exert a biasing force on the second mount in a direction perpendicular to and offset from the pivot axis.

5. The SMA actuator of claim 4, wherein when heat is applied to the first SMA element initially in the extended state, the first SMA element changes to the contracted state and exerts a force on the second SMA element via the lever, thereby changing the second SMA element from the contracted state to the extended state and pivoting the lever from the second position to the first position.

6. The SMA actuator of claim 4, wherein when heat is applied to the second SMA element initially in the extended state, the second SMA element changes to the contracted state and exerts a force on the first SMA element via the lever, thereby changing the first SMA element from the contracted state to the extended state and pivoting the lever from the first position to the second position.

7. The SMA actuator of claim 4, wherein the lever is pivotable to the first position in response to heat being applied to the first SMA element and to the second position in response to heat being applied to the second SMA element, and wherein the lever is pivotable to a desired position among an infinite number of possible positions between the first position and the second position by heating either the first SMA element or the second SMA element and stopping the lever in response to a sensor being triggered.

8. The SMA actuator of claim 4, further comprising a controller that is in electrical communication with a power source, a first sensor, and a second sensor, wherein the first sensor is activated when the lever is in the first position and sends a signal to the controller indicating to cutoff power supply to the first SMA element from the power source, and wherein the second sensor is activated when the lever is in the second position and sends a signal to the controller indicating to cutoff power supply to the second SMA element from the power source.

9. The SMA actuator of claim 1, wherein the mount is rotatably mounted to the lever, thereby minimizing frictional forces between the SMA element and the mount as the SMA element bears against the mount when changing between the extended state and the contracted state.

10. The SMA actuator of claim 1, further comprising an actuator coupled to the lever and moveable between an extended position corresponding to the first position of the lever and a retracted position corresponding to the second position of the lever.

11. The SMA actuator of claim 10, wherein the actuator is pivotably coupled to an elongated slot adjacent a distal end of the lever, the elongated slot defining a slot axis along which the actuator may translate when the actuator moves between the extended position and the retracted position.

12. The SMA actuator of claim 10, wherein the actuator is movable along an actuator axis that is perpendicular to the pivot axis when moving between the extended position and the retracted position.

13. The SMA actuator of claim 10, wherein the mount is rotatably mounted to the lever, thereby minimizing frictional forces between the SMA element and the mount as the SMA element bears against the mount when changing between the extended state and the contracted state.

14. A shape memory alloy (SMA) actuator comprising:
a lever pivotable about a pivot axis between a first position and a second position;
an actuator coupled to the lever and moveable between an extended position corresponding to the first position of the lever and a retracted position corresponding to the second position of the lever; and
a shape memory alloy (SMA) element coupled to the lever, wherein the SMA element, in response to heat being applied to the SMA element, changes between an extended state and a contracted state;
wherein the lever pivots from the first position corresponding to the SMA element being in the contracted state to the second position corresponding to the SMA element being in the extended state.

15. The SMA actuator of claim 14, wherein the actuator is movable along an actuator axis that is perpendicular to the pivot axis when moving between the extended position and the retracted position.

16. The SMA actuator of claim 15, wherein the actuator is pivotably coupled to an elongated slot adjacent a distal end of the lever, the elongated slot defining a slot axis along which the actuator may translate when the actuator moves between the extended position and the retracted position.

17. The SMA actuator of claim 14, further comprising a controller; a power source; a first sensor; and a second sensor, wherein the first sensor is configured to detect when the lever is in the first position, wherein the second sensor is configured to detect when the lever is in the second position, and wherein the controller is configured to control the power source based on feedback from the first sensor and the second sensor.

18. The SMA actuator of claim 14, further comprising a spring biasing the lever toward the second position.

19. The SMA actuator of claim 18, further comprising a housing enclosing the lever and the SMA element.

20. The SMA actuator of claim 19, further comprising a cable coupled to the lever and extending outside of the housing.
